(19) United States
(12) Patent Application Publication
(10) Pub. No.: US 2024/0370616 A1
(43) Pub. Date: Nov. 7, 2024

(54) CRITICAL PATH ANALYSIS METHOD AND ELECTRIC DEVICE

(71) Applicant: Realtek Semiconductor Corporation, Hsinchu (TW)

(72) Inventors: Kuan-Han HO, Hsinchu (TW); Ying-Chieh CHEN, Hsinchu (TW); Mei-Li YU, Hsinchu (TW); Yu-Lan LO, Hsinchu (TW)

(21) Appl. No.: 18/648,463

(22) Filed: Apr. 28, 2024

(30) Foreign Application Priority Data
May 3, 2023 (TW) 112116452

(51) Int. Cl. G06F 30/3308

(52) U.S. Cl. CPC G06F 30/3308

(57) ABSTRACT

A critical path analysis method includes: obtaining multiple critical paths of a digital circuit; sorting the critical paths according to stage counts of the critical paths and dividing the critical paths into batches; using a simulation program with integrated circuit emphasis (SPICE) tool to analyze the batches sequentially to generate a static timing analysis (STA) report with respect to the critical paths.

### RELATED APPLICATIONS

This application claims priority to Taiwan Application Serial Number 112116452 filed May 3, 2023, which is herein incorporated by reference.

### BACKGROUND

### Field of Invention

This disclosure is related to static timing analysis of digital circuits, specifically a critical path analysis method that can improve speed.

### Description of Related Art

Static Timing Analysis (STA) is a workflow for calculating the timing of digital circuits. Considering a logic circuit between two flip-flops, this logic circuit contains multiple logic gates, each with its own delay. There are multiple paths between the previous flip-flop and the subsequent flip-flop for data transmission, with the path having the maximum delay referred to as the critical path. If the data cannot be transmitted to the subsequent flip-flop in time due to the delay, it does not meet the specification requirements. STA can analyze whether the timing of data transmission between the two flip-flops meets the specification requirements without actually inputting signals to the digital circuit.

### SUMMARY

Embodiments of the present disclosure provide a critical path analysis method executed by a computer system. The critical path analysis method includes: obtaining multiple critical paths of a digital circuit; sorting the critical paths according to stage counts of the critical paths and dividing the critical paths into multiple batches; and using a simulation program with integrated circuit emphasis (SPICE) tool to analyze the batches sequentially to generate a static timing analysis (STA) report with respect to the critical paths.

From another aspect, embodiments of the present disclosure provide an electric device including a memory and a processor which is communicatively connected to the memory. The memory stores multiple instruction executed by the processor to perform the critical path analysis method.

In the aforementioned method and electric device, the analysis of the critical paths is accelerated.

### BRIEF DESCRIPTION OF THE DRAWINGS

The invention can be more fully understood by reading the following detailed description of the embodiment, with reference made to the accompanying drawings as follows.

FIG. 1 is a schematic diagram illustrating the extraction of a critical path from a digital circuit according to an embodiment.

FIG. 2 is a partial circuit diagram of the combinational logic circuit according to an embodiment.

FIG. 3 is a flowchart illustrating a critical path analysis method according to an embodiment.

FIG. 4 is a schematic diagram illustrating the analysis of the critical paths in batches after grouping according to an embodiment.

FIG. 5 is a schematic diagram illustrating the establishment of a probability distribution model according to an embodiment.

FIG. 6 is a schematic diagram illustrating the electric device according to an embodiment.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

The using of “first”, “second”, “third”, etc. in the specification should be understood for identifying units or data described by the same terminology, but are not referred to particular order or sequence.

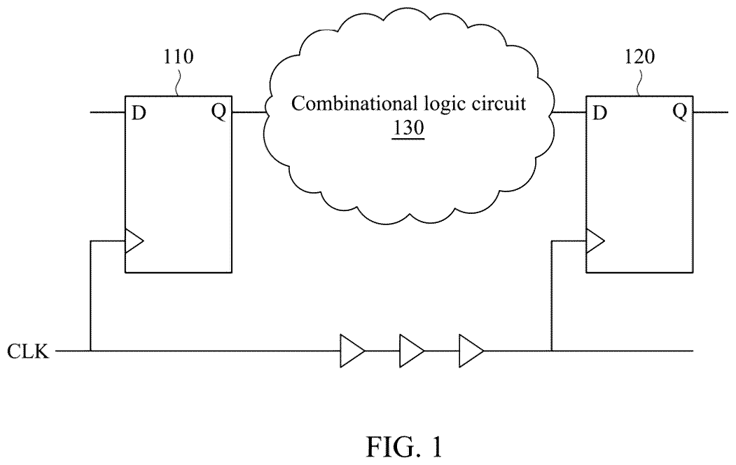

FIG. 1 is a schematic diagram illustrating the extraction of a critical path from a digital circuit according to an embodiment. Referring to FIG. 1, the digital circuit includes a flip-flop 110 and a flip-flop 120, with a combinational logic circuit 130 positioned between an output terminal Q of the flip-flop 110 and an input terminal D of the flip-flop 120. A clock signal CLK is provided to the flip-flop 110 and the flip-flop 120. The critical path between the flip-flop 110 and the flip-flop 120 can be obtained by calculating a slack value, which is defined as the required time minus the arrival time. The arrival time is defined as the time required for the data to reach the flip-flop 120 after the clock signal CLK is provided. The required time is the latest time by which the data must reach the flip-flop 120 in order to be correctly captured when the clock terminal of the flip-flop 120 is triggered.

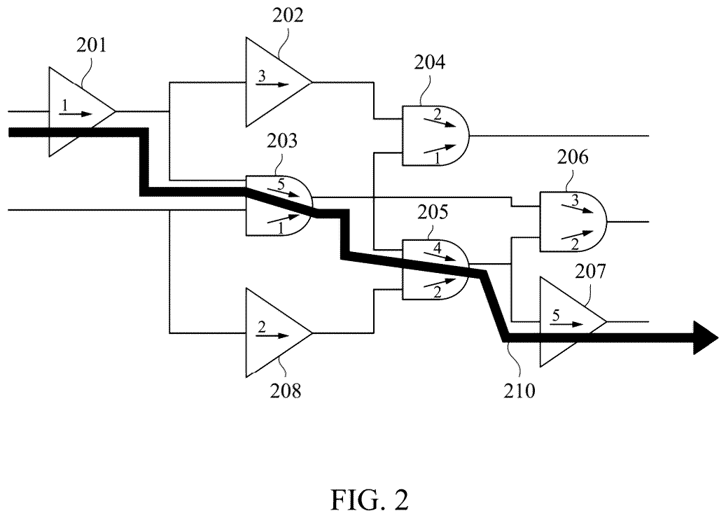

FIG. 2 is a partial circuit diagram of the combinational logic circuit according to an embodiment. Taking the circuit of FIG. 2 as an example, logic gates 201-208 are shown with numbers inside the logic gates representing delays. For instance, there is a one-unit time of delay between the input and output of the logic gate 201; there is a five-unit time of delay between the upper input and output of the logic gate 203, and a one-unit time of delay between the lower input and output of the logic gate 203, and so on. This circuit has multiple paths, each path consisting of several logic gates. For example, the logic gates 201, 202, and 204 form one path while the logic gates 201, 203, and 206 form another path, and so on. By calculating the slack values, it can be determined that a path 210, composed of the logic gates 201, 203, 205, and 207, has the maximum delay and is thus referred to as the critical path. If the slack value of the critical path 210 is less than 0, it indicates that the circuit in FIG. 2 does not meet the timing specification. Those skilled in the art should understand the calculation of the slack value, and it is not described here for the sake of brevity.

The above calculation considers the level of logic gates; however, when considering the level of transistors, a simulation program with integrated circuit emphasis (SPICE) tool is needed to account for the delay variation of each logic gate under a specific process condition. For example, under certain process conditions, the delay of the logic gate 207 might be slightly greater than 5, while under another process condition, the delay of the logic gate 207 might be slightly less than 5. The process conditions include specific component sizes, masks, temperature, etc., and are not limited in this disclosure. Due to the numerous parameters involved in the process conditions, it is not feasible to exhaustively simulate all parameters. In some embodiments, the SPICE tool is combined with a Monte Carlo algorithm which generates multiple samples, and each example represents a process condition. If the number of the samples is large enough, the accuracy of the simulation will be high enough. For a particular critical path, multiple process conditions need to be simulated to determine whether the corresponding slack value remains greater than 0. The entire circuit includes multiple flip-flops, and there is a critical path between each pair of flip-flops. Analyzing such many critical paths requires a significant amount of time. The present disclosure proposes a critical path analysis method that can accelerate the above analysis process.

In the above-described embodiments, the SPICE tool is used in combination with the Monte Carlo algorithm, but this disclosure is not limited to this. In some embodiments, the process conditions can be set based on predefined probability distributions, templates, or test sets, and then the delay of each logic gate can be determined using the SPICE tool.

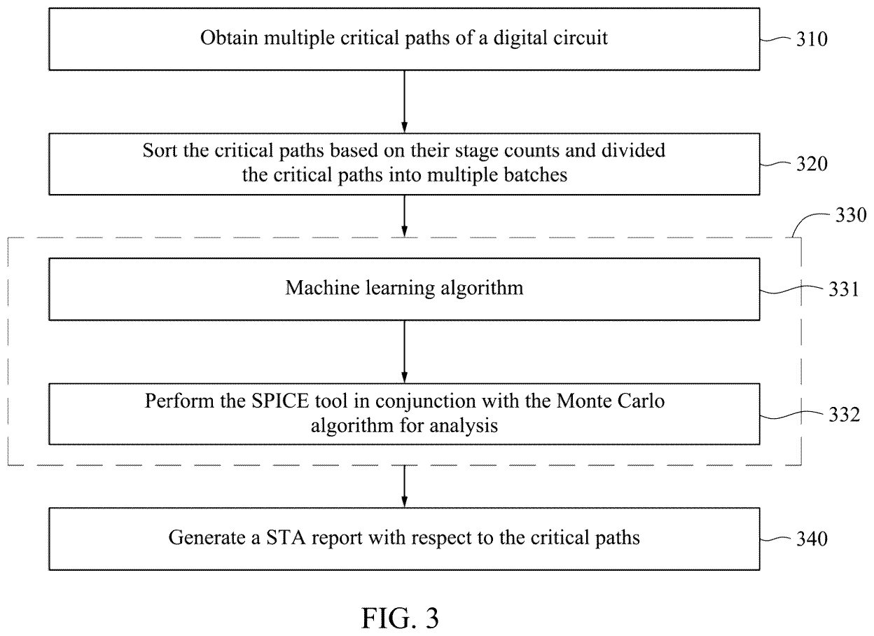

FIG. 3 is a flowchart illustrating a critical path analysis method according to an embodiment. Referring to FIG. 3, in step 310, multiple critical paths of a digital circuit are obtained first. As previously described, the critical path can be obtained using any known static timing analysis method. Each critical path has a stage count, which is also equal to the number of cells. For example, the stage count of the critical path 210 in FIG. 2 is equal to 4 with four cells being the logic gates 201, 203, 205, and 207.

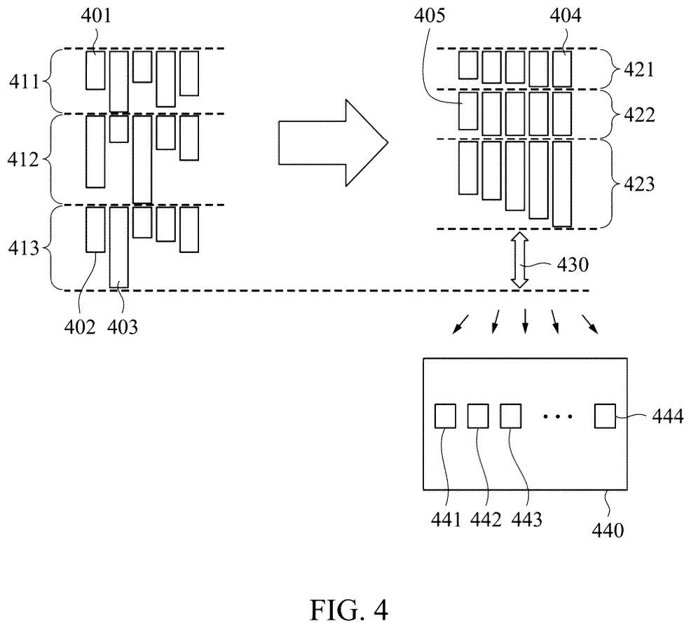

When the stage count of a critical path is larger (also referred to as a longer critical path), the time required for analysis is longer. If long paths and short paths are assigned to the same batch for analysis, short paths may finish analyzing while still waiting for long paths to complete before executing the next batch, resulting in increased overall time spent. Therefore, in this embodiment, critical paths with similar stage counts are assigned to the same batch for analysis to reduce waiting time. Specifically, in step 320, the critical paths are sorted based on their stage counts and divided into multiple batches. Next, in step 330, the SPICE tool is used to analyze these batches sequentially. FIG. 4 is a schematic diagram illustrating the analysis of the critical paths in batches after grouping according to an embodiment. Referring to FIG. 4, batches 411-413 represent the grouping results of the prior art (before sorting), and each batch contains multiple critical paths to be analyzed (such as critical paths 401-403). In the figure, the length of the critical path 401 represents the stage count; the larger the length, the larger the stage count, and the longer the time required for analysis. Batches 411-413 are executed sequentially (in time order). Within the same batch, the short paths must wait for the long paths to finish analyzing before executing the next batch. For example, in the batch 413, after the critical path 402 is analyzed, it must wait for the critical path 403 to finish analyzing before ending the batch 413. In the present embodiment, all critical paths are sorted first, and batches 421-423 are generated based on the stage count order. In other words, a critical path 404 has the maximum stage count in the batch 421, and a critical path 405 has the minimum stage count in the batch 422, but the stage count of the critical path 404 is smaller than the stage count of the critical path 405. Since the stage counts of the critical paths within the same batch are similar, the waiting time is shortened. Compared to the unsorted results, the total required time is reduced by a time length 430 after sorting.

Herein, we demonstrate that after sorting, the execution time is minimized. Let's assume there are n critical paths, divided into m batches, where n and mare positive integers. After sorting, the stage counts of these n critical paths are represented as {α₁, α₂, . . . , αₙ}, where α₁≤α₂≤ . . . ≤αₙ₋₁≤αₙ. Each batch has n/m critical paths, and the stage counts are arranged in ascending order. The stage counts of the critical paths in the first batch are

$$\{ {a}_{1} , {a}_{2} , … , {a}_{\frac{n}{m}} \} ,$$

in the second batch are

$$\{ {a}_{\frac{n}{m} + 1} , {a}_{\frac{n}{m} + 2} , … , {a}_{\frac{2 n}{m}} \} ,$$

and in the m-th batch are {α_((m−1)n)/m+1), α_((m−1)n)/m+2), . . . , αₙ}. Therefore, the maximum stage count T₁ in the first batch is calculated as the following equation 1. The maximum stage count T₂ in the second batch is calculated as the following equation 2. The maximum stage count Tₘ in the m-th batch is calculated as the following equation 3.

$${T}_{1} = max \{ {a}_{1} , {a}_{2} , … , {a}_{\frac{n}{m}} \} = {a}_{\frac{n}{m}} \qquad [ Equation 1 ]$$

$${T}_{2} = max \{ {a}_{\frac{n}{m} + 1} , {a}_{\frac{n}{m} + 2} , … , {a}_{\frac{2 n}{m}} \} = {a}_{\frac{2 n}{m}} \qquad [ Equation 2 ]$$

$$T\_m = max \{ a\_ ( ( m - 1 ) n ) / m + 1 ) , a\_ ( ( m - 1 ) n ) / m + 2 , … , a\_n \} = a\_n \qquad [ Equation 3 ]$$

If the critical paths are not sorted, the first batch must contain a stage count greater than

$${a}_{\frac{n}{m}} .$$

The maximum stage count T₁′ for the first batch is shown in equation 4. Similarly, the maximum stage count T₂′ for the second batch is shown in equation 5, and the maximum stage count Tₘ′ for the m-th batch is shown in equation 6.

$${T}_{1}^{′} = max \{ {a}_{1} , {a}_{2} , … , {a}_{\frac{n}{m} + i} \} \geq {T}_{1} , 0 \leq i < \frac{( m - 1 ) n}{m} , i ∈ N \qquad [ Equation 4 ]$$

$${T}_{2}^{′} = max \{ … , {a}_{\frac{2 n}{m} \pm j} \} \geq {T}_{2} , 0 \leq j < \frac{n}{m} , j ∈ N \qquad [ Equation 5 ]$$

$${T}_{m}^{′} = max \{ … , {a}_{n} \} = {a}_{n} = {T}_{m} \qquad [ Equation 6 ]$$

Hence, the total time required after sorting is less than the total time required before sorting, as shown in equation 7. This proves that the total time required after sorting is the minimum.

$${T}_{1} + {T}_{2} + … + {T}_{m} = {a}_{\frac{n}{m}} + {a}_{\frac{2 n}{m}} + … + {a}_{n} \leq {T}_{1}^{′} + {T}_{2}^{′} + … + {T}_{m}^{′} \qquad [ Equation 7 ]$$

In some embodiments, the SPICE tool and Monte Carlo algorithm are executed by a computer system 440. The computer system 440 can be a personal computer, server, distributed system, etc. The computer system 440 includes multiple cores 441-444, each core can be a thread, virtual machine, central processor, computing node, or a computing logic circuit, implemented in hardware or software, and is not limited to the present disclosure. In this system, the cores 441-444 are used to process the critical paths in parallel. Due to limited resources, the number of the cores 441-444 is less than the total number of the critical paths in the digital circuit. Therefore, these critical paths must be divided into multiple batches for processing. When executing a particular batch, these cores 441-444 process multiple critical paths in parallel within the batch. When the total number of the critical paths remains unchanged, the fewer the number of the batches 421-423, the more critical paths there are in a single batch, which means that more critical paths can be processed in parallel at once, reducing the total time required. The number of the batches is not limited in the disclosure.

In the above implementation, each critical path is located between two flip-flops. However, in other implementations, the critical paths can belong to other types. For example, a critical path can be located between an input port and a flip-flop, between a flip-flop and an output port, or between an input port and an output port, etc. This disclosure is not limited to these configurations.

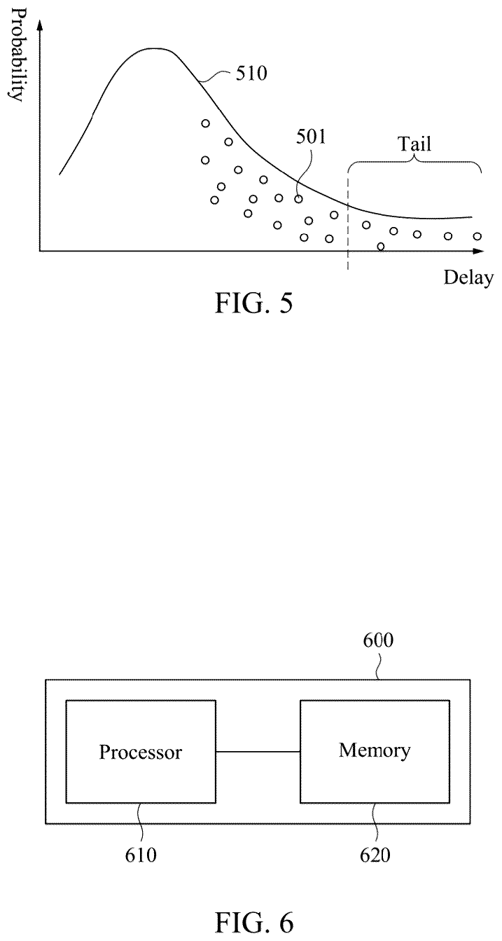

Referring back to FIG. 3, in this implementation, the step 330 includes steps 331 and 332. In the step 331, a machine learning algorithm is executed to establish a probability distribution model. In step 332, the SPICE tool is performed in conjunction with the Monte Carlo algorithm for analysis. Traditionally, executing the Monte Carlo algorithm generates a large number of samples and takes a considerable amount of time. In some embodiment, a probability distribution model is established using a smaller number of samples, and then less probable tail samples are used for simulation, which reduces the number of samples and accelerates the analysis. FIG. 5 is a schematic diagram illustrating the establishment of a probability distribution model according to an embodiment. To analyze a particular critical path, multiple initial samples are first generated (e.g., a sampling 501). These initial samples can be generated randomly or based on any probability distribution. Each initial sample represents a process condition, and the delay of the logic gates is obtained through SPICE tool under the corresponding process condition. In other words, the samples are configured to determine the delay of logic gates. Then, a probability distribution model 510 is established based on the simulation results (i.e. delays) of these initial samples. For example, this probability distribution model 510 is assumed to be a Gaussian distribution, and the mean and variance of the Gaussian distribution are calculated using the simulation results of the initial samples. In FIG. 5, the horizontal axis represents delay, with the left side of the axis indicating better performance (i.e. lower delay) and the right side indicating worse performance (i.e. higher delay, more likely to be out of specification). The vertical axis represents the probability of sampling. The goal is to simulate whether the system can still meet the specifications under extreme conditions. Therefore, after establishing the probability distribution model 510, multiple tail samples are obtained. These tail samples are located on the right side of FIG. 5, with lower probabilities but resulting in worse performance. Next, the critical path is simulated based on these tail samples. The above steps can be repeated in multiple iterations. In each iteration, a portion of the samples is generated, and a new probability distribution model is established after performing the simulation, and tail samples are obtained from the new probability distribution model for the next iteration. In this way, the focus can be placed on process conditions that cause low performance, which can reduce the number of samples compared to conventional methods.

In this embodiment, acceleration is achieved through the step 331. However, the step 331 can be omitted, and only the Monte Carlo algorithm is used to generate samples in some embodiments. In other embodiments, the step 330 can adopt any modified version of the Monte Carlo algorithm. Alternatively, as mentioned above, the step 330 may use any means instead of the Monte Carlo algorithm to determine the process conditions to be simulated in some embodiments.

Referring back to FIG. 3, in step 340, a STA report with respect to the critical paths is generated. In some embodiments, the STA report includes the slack value for each critical path. If the slack value is less than zero, it is determined that the corresponding critical path does not meet the timing specification.

The method in FIG. 3 can be executed by any electric device. FIG. 6 is a schematic diagram illustrating the electric device according to an embodiment. Referring to FIG. 6, the electric device 600 can be a personal computer, laptop, server, distributed computer, cloud server, industrial computer, or various electric devices with computing capabilities, but the disclosure is not limited to these examples. In some embodiments, the electric device 600 is the computer system 440 shown in FIG. 4. The electric device 600 includes a processor 610 and a memory 620. The processor 610 is communicatively connected to the memory 620, and this communication connection can be achieved through any wired or wireless means, or via the Internet. The processor 610 can be a central processor, microprocessor, microcontroller, or application-specific integrated circuit. The memory 620 can be random access memory, read-only memory, flash memory, floppy disk, hard disk, CD, USB drive, magnetic tape, or a database accessible via the internet. The memory stores multiple instructions, and the processor 610 executes these instructions to perform the critical path analysis method shown in FIG. 3.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A critical path analysis method executed by a computer system, the critical path analysis method comprising:
obtaining a plurality of critical paths of a digital circuit;
sorting the critical paths according to stage counts of the critical paths and dividing the critical paths into a plurality of batches; and
using a simulation program with integrated circuit emphasis (SPICE) tool to analyze the batches sequentially to generate a static timing analysis (STA) report with respect to the critical paths.

2. The critical path analysis method of claim 1, wherein one of the critical paths is positioned between two flip-flops.

3. The critical path analysis method of claim 1, wherein the batches comprise a first batch and a second batch, a maximum stage count of a plurality of first critical paths of the first batch is less than a minimum stage count of a plurality of second critical paths of the second batch.

4. The critical path analysis method of claim 1, wherein the step of using the SPICE tool to analyze the batches sequentially comprises:
processing, by a plurality of cores of the computer system, a plurality of third critical paths of one of the batches in parallel.

5. The critical path analysis method of claim 4, wherein a number of the cores is less than a number of the critical paths of the digital circuit.

6. The critical path analysis method of claim 1, wherein the step of using the SPICE tool to analyze the batches sequentially comprises:
generating a plurality of initial samples for one of the critical paths;
establishing a probability distribution model according to a simulation result of the initial samples;
obtaining a plurality of tail samples according to the probability distribution model; and
performing simulation on the one of the critical paths according to the tail samples.

7. The critical path analysis method of claim 6, wherein the one of the critical paths comprises a plurality of logic gates, and the initial samples and the tail samples are configured to determine delays of the logic gates.

8. The critical path analysis method of claim 1, wherein the step of using the SPICE tool to analyze the batches sequentially comprises:
performing a Monte Carlo algorithm.

9. The critical path analysis method of claim 1, wherein the STA report comprises a slack value of one of the critical paths.

10. The critical path analysis method of claim 9, further comprising:
if the slack value is less than zero, determining that the one of the critical paths does not meet a timing specification.

11. An electric device, comprising:
a memory storing a plurality of instructions; and
a processor, communicatively connected to the memory, and configured to execute the instructions to perform a plurality of steps:
obtaining a plurality of critical paths of a digital circuit;
sorting the critical paths according to stage counts of the critical paths and dividing the critical paths into a plurality of batches; and
using a simulation program with integrated circuit emphasis (SPICE) tool to analyze the batches sequentially to generate a static timing analysis (STA) report with respect to the critical paths.

12. The electric device of claim 11, wherein one of the critical paths is positioned between two flip-flops.

13. The electric device of claim 11, wherein the batches comprise a first batch and a second batch, a maximum stage count of a plurality of first critical paths of the first batch is less than a minimum stage count of a plurality of second critical paths of the second batch.

14. The electric device of claim 11, wherein the step of using the SPICE tool to analyze the batches sequentially comprises:
processing, by a plurality of cores of a computer system, a plurality of third critical paths of one of the batches in parallel.

15. The electric device of claim 14, wherein a number of the cores is less than a number of the critical paths of the digital circuit.

16. The electric device of claim 11, wherein the step of using the SPICE tool to analyze the batches sequentially comprises:
generating a plurality of initial samples for one of the critical paths;
establishing a probability distribution model according to a simulation result of the initial samples;
obtaining a plurality of tail samples according to the probability distribution model; and
performing simulation on the one of the critical paths according to the tail samples.

17. The electric device of claim 16, wherein the one of the critical paths comprises a plurality of logic gates, and the initial samples and the tail samples are configured to determine delays of the logic gates.

18. The electric device of claim 11, wherein the step of using the SPICE tool to analyze the batches sequentially comprises:
performing a Monte Carlo algorithm.

19. The electric device of claim 11, wherein the STA report comprises a slack value of one of the critical paths.

20. The electric device of claim 19, wherein the steps further comprise:
if the slack value is less than zero, determining that the one of the critical paths does not meet a timing specification.
